(19) United States
(12) Patent Application Publication
(10) Pub. No.: US 2008/0089967 A1
(43) Pub. Date: Apr. 17, 2008

(54) APPARATUS FOR TWISTING EXTRUSIONS OF ICING AND THE LIKE

(76) Inventor: Thomas Bourque, Littleton, CO (US)

Correspondence Address: SHERIDAN ROSS PC, 1560 BROADWAY, SUITE 1200, DENVER, CO, 80202, US

(21) Appl. No.: 11/866,939

(22) Filed: Oct. 3, 2007

Related U.S. Application Data
(60) Provisional application No. 60/829,345, filed on Oct. 13, 2006.

(51) Int. Cl. A23P 1/00; B43K 5/00; B65D 5/72

(52) U.S. Cl. 425/183; 222/568; 401/261; 425/190; 425/191

(57) ABSTRACT

A coupler for dispensing, e.g., icing, from a squeezable bag, wherein the icing is twisted as it is dispensed. The coupler may attach between an icing bag nozzle and an icing dispensing tip, wherein members of the coupler are rotatable relative to one another, e.g., via a user's fingers or thumb. Alternatively, the coupler may include a modified icing bag nozzle as one of its members. The coupler may be used for twisting extrusions of other extrudable substances, e.g., chocolate mousse, etc.

The present application claims the benefit of U.S. Provisional Patent Application No. 60/829,345 filed Oct. 13, 2006 which is fully incorporated herein by reference.

### RELATED FIELD OF THE INVENTION

The present invention is related to an apparatus and method for twisting during extrusion of a substance generally having a consistency similar to cake decorating icing, and more particularly, for twisting icing as it is extruded for, e.g., cake decorating, wherein, in one embodiment, the twisting may be performed via a rotational twisting force that can be exerted by a user's finger(s) or thumb.

### BACKGROUND

There are various techniques for extruding substances. However, twisting of extruded substances can be more complicated than necessary, and/or no simple apparatus has been available for twisting particular extruded substances. For example, in the context cake decorating, the components of a typical cake icing dispenser 8 are shown in FIG. 1. These components are:
(a) An icing holding bag 10 for retaining icing prior to dispensing;
(b) A bag nozzle 14 for insertion into the bag 10 as shown by arrow 18, wherein the bag nozzle has an icing passageway extending between the large end 22 and the small end 26. When the bag nozzle 14 is inserted into the bag 10, small end 26 protrudes from the bag opening 30, and since the large end 22 has a greater diameter than the opening 30, the large end remains in the bag;
(c) An icing dispensing tip 34 from which icing is dispensed onto, e.g., a cake. In particular, the icing dispensing tip 34 also has an icing passageway extending between a large tip end 38 and a small tip end 42. When the components are fully assembled, the large tip end 38 fits over the small end 26 of the nozzle 14 so that icing can flow from the nozzle passageway to the passageway of the tip 34, and then out the small tip end 42. Note that the small tip end 42 may have various configurations depending on the shape desired for the icing dispensed. Typically, there will be a plurality of such icing dispensing tips 34, wherein different tips yield differently shaped icing extrusions;
(d) A connector 46 having an opening there through with a larger open end 50 and a smaller open end 52. The smaller open end 52 is smaller than the large tip end 38. Thus, when the tip 34 is inserted into the opening of the connector 46, wherein the small tip end 42 protrudes from the smaller open end 52, the tip 34 seats against the interior sides of the connector opening. Adjacent to the larger open end 50, and interior to the opening, are threads for mating with corresponding threads 54 on the exterior surface of the bag nozzle 14.

Thus, when nozzle 14 is positioned within the bag opening 30, and the tip 34 is positioned on the small end 26 of the nozzle 14, the connector 46 can then be threaded onto the nozzle threads 54 for securing the tip 34 between the nozzle and the connector.

Such a typical icing dispenser 8 does not allow the tip 34 to be easily rotated relative to, e.g., the bag 10 since the nozzle 14 fixedly secured in the bag opening 30, and the tip 34 is tightly secured to the nozzle. Thus, for a cake decorator to provide a twist in the icing dispensed from the dispenser 8, the decorator must twist the entire dispenser 8. However, when icing is being dispensed from the bag 10, the dispenser 8 is likely to be very awkward for a user to rotate while simultaneously applying pressure to the bag 10 for forcing icing through the tip end 42. In general, it is very difficult for a user to provide uniform twists in the icing being dispensed when the bag 10 is even moderately filled with icing.

Accordingly, it would be desirable to have apparatus that can be used with the components of such typical icing dispensers, wherein twists in the dispensed icing is substantially easier to produce.

### SUMMARY

A coupler for placing between an icing bag and an icing dispensing tip is disclosed, wherein the coupler allows the icing extruded from the dispensing tip to be twisted during the extrusion.

In one embodiment, the novel coupler includes: (i) a housing for connecting to an icing bag nozzle (e.g., bag nozzle 14 of FIG. 1), (ii) a rotatable member that connects to the housing such that the rotatable member is manually rotatable relative to the housing, and (iii) an icing tip connector for securing any one of a plurality of icing tips to the rotatable member so that the secured tip rotates synchronously when a user rotates the rotatable member.

In one embodiment, the rotatable member is rotatable using only a rotational force supplied by a user's finger(s) and/or thumb.

In one embodiment, the components or members of the icing dispensing coupler can be assembled into the coupler manually without the use of tools. In particular, the members may snap and/or thread together by hand. Moreover, the coupler may be manually (and without tools) disassembled for, e.g., cleaning. In at least one embodiment, the icing tip connector described hereinabove can be disconnected from the rotatable member for attaching a different icing tip such as an icing tip whose icing extrusion opening is differently shaped for obtaining a differently shaped icing extrusion.

In one embodiment, the novel coupler is designed to attach to a conventional prior art icing bag nozzle (e.g., nozzle 14, FIG. 1), and attach conventional prior art icing bag tips (e.g., tip 34, FIG. 1) thereto. Accordingly, the coupler of the present disclosure can be used with icing dispensing bags, nozzles, and tips that a user already has and uses.

In one embodiment, the novel coupler couples directly to the icing bag, wherein a first member of the coupler is a modified icing bag nozzle, and a second member is rotatable relative to the first member.

In one embodiment, the components or members of the coupler may be sold and/or distributed together with (or separately from) an icing bag, the icing bag nozzle, the tips, and/or other components used in extruding icing (or another substance of, e.g., similar consistency, e.g., chocolate mousse, etc.). In particular, the components of the coupler may be provided in kit together with an icing bag, an icing bag nozzle, icing tips, and/or other components used in extruding icing (or substances of a similar consistency).

Various combinations of the above described embodiments may have their recited features combined to yield further embodiments of the coupler.

Additional features and benefits of the novel coupler may be described and shown in the accompanying drawings together with the description hereinbelow. Moreover, such additional features and benefits may be provide important novelty for patent protection. In particular, the above-described embodiments and configurations are neither complete nor exhaustive. As will be appreciated, other embodiments of the coupler are possible utilizing, alone or in combination, one or more of the features set forth above or described in detail below. It is also to be understood that the invention disclosed herein is defined by the claims, regardless of the disclosure in this Summary section.

### BRIEF DESCRIPTION OF THE DRAWINGS

FIG. 1 shows the components of a prior art non-rotatable icing dispenser.

FIG. 2 shows a partial cross section of a housing 64 and a rotatable member 100 of a first embodiment of the coupler (60) for dispensing a twisted extrusion of icing and the like.

FIG. 3 shows a partial cross section of a fully assembled first embodiment of a coupler (60) for dispensing a twisted extrusion of icing and the like.

FIG. 4 shows a housing 64 of a first embodiment of a coupler (60) for dispensing a twisted extrusion of icing and the like.

FIG. 5 shows the members of the first embodiment of the coupler for dispensing a twisted extrusion of icing and the like, wherein the members are generally ordered according to how they fit together.

FIG. 6 shows an embodiment of a fully assembled coupler (60) attached an icing bag 10 and an icing tip 34.

FIG. 7 shows another embodiment of a fully assembled coupler (60) attached an icing bag 10 and an icing tip 34 for providing an icing dispenser 128, wherein a wheel 136 of various embodiments may be provided for allowing a user to more easily rotate the portion of the coupler 60 for twisting the extruded icing.

FIG. 8 shows a second embodiment of the coupler (60a) fully assembled and attached to both an icing bag and an icing tip 34.

FIGS. 9A and 9B show, respectively, top and side views of a second embodiment of the coupler (60a) for dispensing a twisted extrusion of icing and the like, wherein a dispensing tip 34 is not attached thereto.

FIGS. 10A and 10B show, respectively, top and side views of the connector 46a which snaps onto the rotatable member 100a.

FIGS. 11A and 11B show, respectively, top and side views of the rotatable member 100a of the second embodiment of the coupler.

FIGS. 12A and 121B show, respectively, top and side views of the housing member 64a of the second embodiment of the coupler (64a).

FIGS. 13A and 13B show, respectively, a cross section and an external view of the members of a third embodiment of the coupler (60b).

FIGS. 14A and 14B show, respectively, a cross section and an external view of the members of a third embodiment of the coupler (60b) assembled together, but without a dispensing tip 34 attached thereto.

FIG. 15 shows a fourth embodiment of the coupler (60c), wherein the housing member and the bag nozzle are combined.

FIG. 16 illustrates an embodiment of the coupler being used to dispense a twisted extrusion of icing.

### DETAILED DESCRIPTION

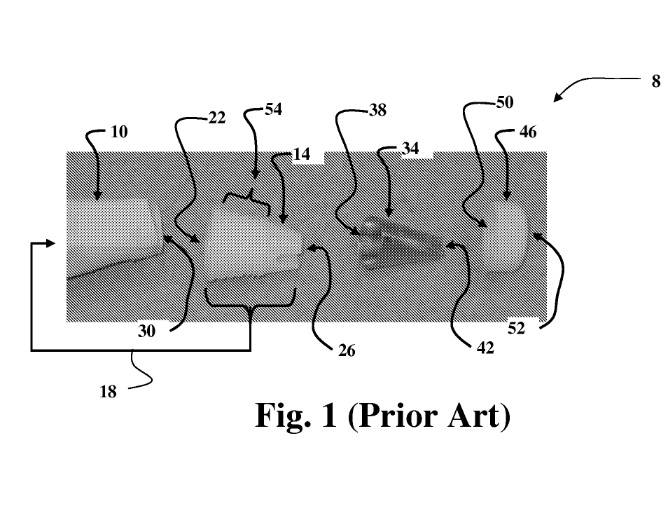

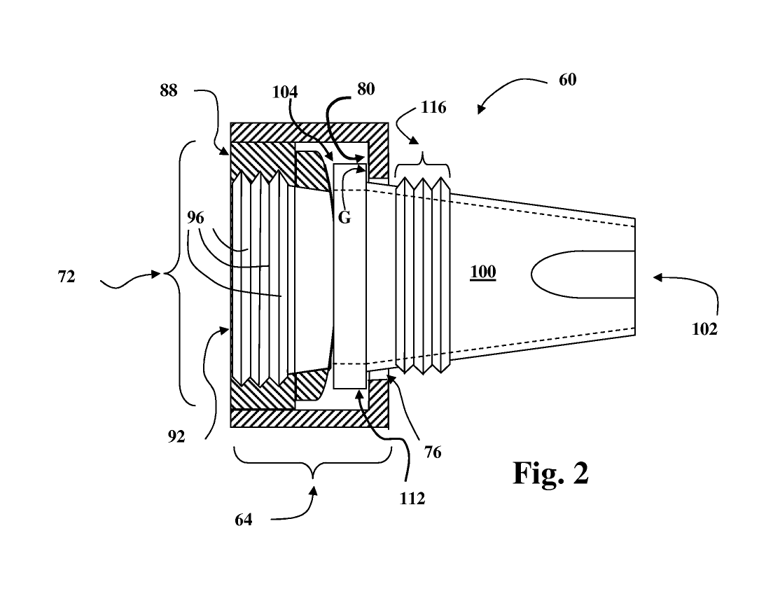

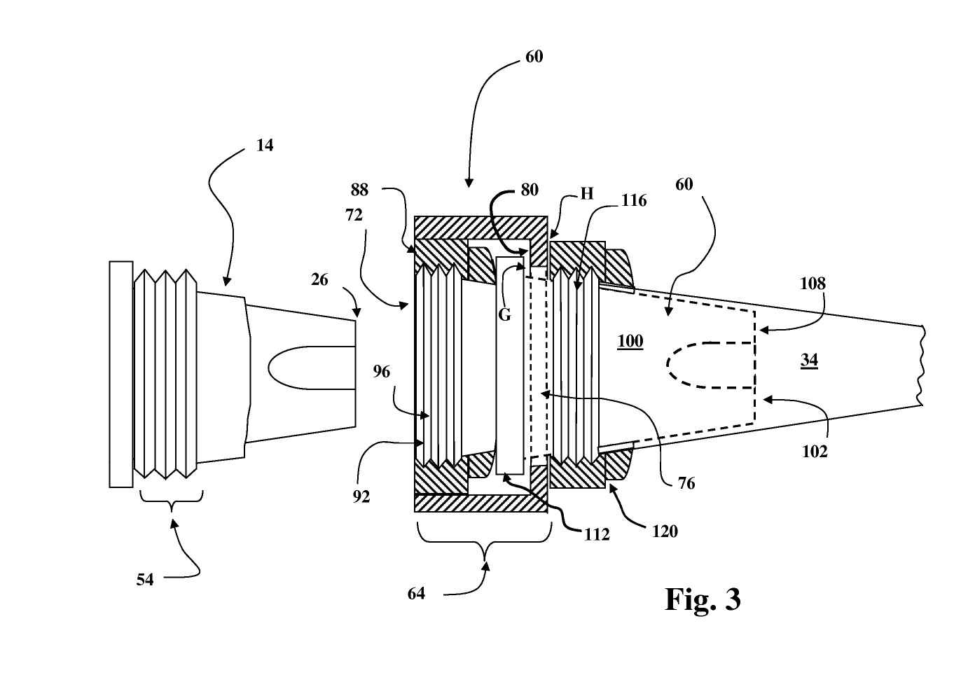

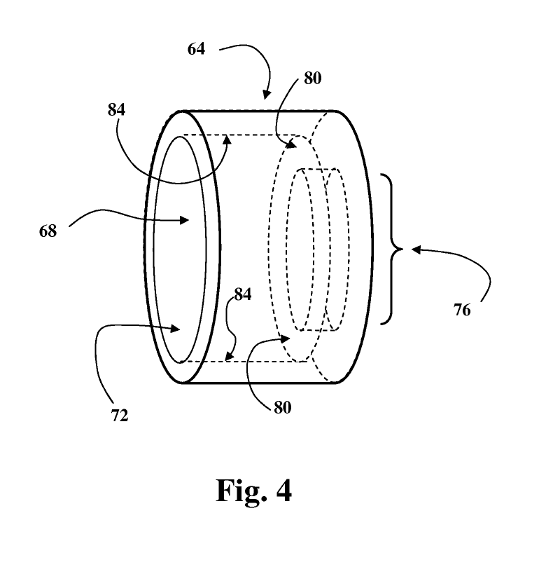

The extrusion dispenser disclosed herein is first described in the context of an icing dispenser that allows the icing to be twisted as it is extruded onto, e.g., a cake or pastry. Accordingly, FIG. 2 shows a partial cross sectional view of one embodiment of a rotatable icing dispensing coupler 60 according to the present disclosure. Using the same labels as in FIG. 1 for substantially identical components, FIG. 3 shows how the coupler 60 fits between the nozzle 14 and the tip 34. The coupler 60 includes a housing member 64 (best shown in FIG. 4) having a cylindrical interior 68 with an opening 72 for insertion of the nozzle 14, and a smaller opening 76 at an opposite end of the housing member. An interior ledge 80 is provided between the interior wall 84 and the opening 76. Within the opening 72, a threaded component 88 (FIGS. 2, 3 and 5) may be press fitted, wherein this component has a center bore 92 through which the small end 26 of the nozzle 14 can be provided for mating the nozzle threads 54 with the threads 96 in the center bore 92. In one embodiment, the threaded component 88 can be a connector 46 (FIG. 1). Any suitable technique for securing the threaded component 88 in the opening 72 may be used as long as the opening 72 is sealed. For example, the following techniques may used: (a) providing threads on the wall 84 and providing mating threads on an exterior surface of the threaded component 88, or (b) gluing, annealing or otherwise fixing the threaded component 88 with the opening 72. However, in one preferred embodiment, the threaded component 88 is detachable and re-attachable in opening 72 of the housing member 64 so that by removing the component 88 from the housing member 64, the surfaces internal to the coupler 60 can be more easily cleaned of food products (e.g., icing) that may collect therein.

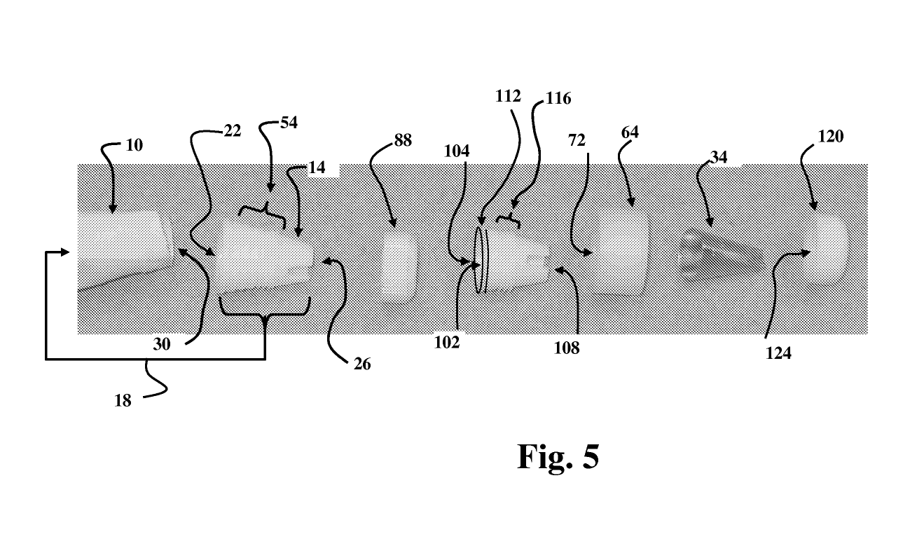

The coupler 60 additionally includes a rotatable member 100 (FIGS. 2, 3, and 5) having an interior 102 through which icing flows from its icing entry end 104 (FIG. 2, and the exploded view of FIG. 5) to the icing exit end 108 from which the icing enters the tip 34 (FIG. 3). At the end 104 of the rotatable member 100, there is a lip 112 that encircles the circular opening of the interior 102 (FIG. 5). The lip 112 is too large to fit through the opening 76 of the housing 64. However, the remainder of the rotatable member 100 readily fits through the opening 76. Note that the lip 112 only loosely contacts the interior ledge 80 about the smaller opening 76 of the housing 64. In particular, there may be gap G (FIG. 2) of less than 1/64 of an inch between the lip 112 and the ledge 80, and this gap G may be less than 0.01 of an inch in some embodiments. Accordingly, since both the lip 112 and the ledge 80 have smooth surfaces, the rotatable member 100 may be easily rotated relative to the housing member 64.

The rotatable member 100 also includes external threads 116, wherein when the member 100 is combined with the housing member 64 as shown in FIGS. 2 and 3, the threads 116 of the member 100 are positioned adjacent to the opening 76. For mating with the threads 116, a tip connector 120 is provided which, in one embodiment, may be a connector 46. However, another embodiment of the tip connector 120 may be used as long as it mates with the threads 116, and secures the dispensing tip 34 to the rotatable member 100 so that icing flows through the tip 34. In the embodiment of FIG. 3, the tip connector 120 has a center threaded bore 124 (shown in FIG. 5), wherein the threads of this bore mate with the threads 116. Note that when the rotatable member 100 is positioned so that its icing entry end 104 is within the cylindrical interior 68 (FIG. 4) of the housing 64 as shown in FIGS. 2 and 3, the mating of the threaded component 88 to the housing 64 secures the rotatable member 100 to the housing 64.

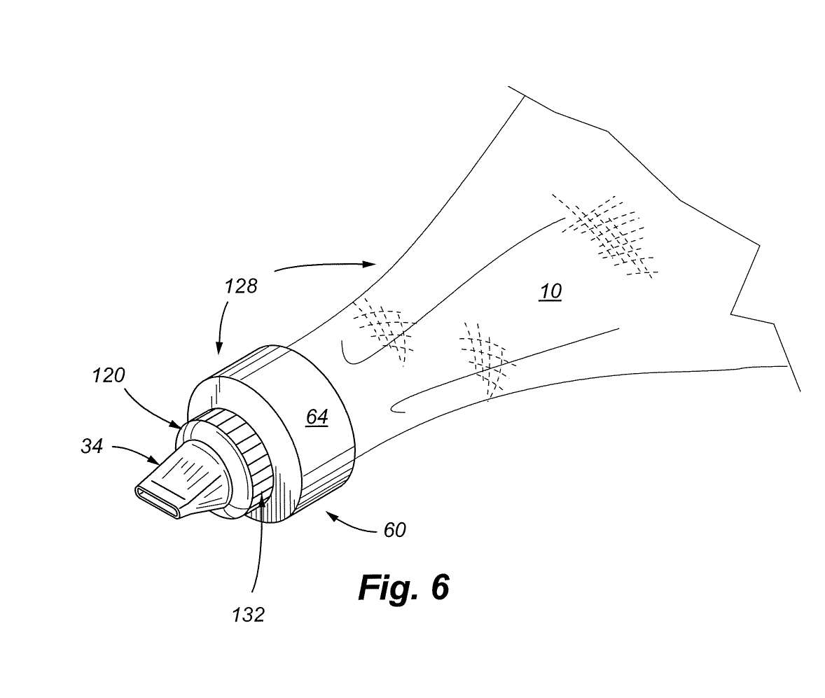

To assemble an operable icing dispenser 128 (FIG. 6) that utilizes the coupler 60, the large end of a conically shaped tip 34 is provided within the bore 124 as shown in FIGS. 3 and 6 so that the large end seats against the interior of the bore 124 and when the tip connector 120 is threaded onto the threads 116 the tip 34 is securely held between the rotatable member 100 and the tip connector 120.

Moreover, when the threads 116 are fully mated with the threads within the bore 124, another small gap H (FIG. 3) may be provided between the tip connector 120 and the housing 64. Such a gap H may be of similar size between the housing 64 and the tip connector 120 as the size of gap G. However, regardless of the size of gap H (or indeed whether one exists at all), it is important that the tip connector 120 with the rotatable member 100 and the tip 34 secured thereto be relatively freely rotatable relative to the housing 64. In particular, it is preferable that the tip connector 120 with the rotatable member 100 and the tip 34 secured thereto be easily rotatable by finger movements of a user such as a cake decorator.

Additionally note that the tip connector 120 may have ridges 132 (FIG. 6) thereon for assisting a user in rotating the combination of the rotatable member 100, the tip connector, and the tip 34 relative to the housing 64 and the bag 10. Note that in one embodiment, the tip connector 120 can be identical to the threaded component 88, prior art connector 46 (FIG. 1). Moreover, both the tip connector 120 and the threaded component 88 can be identical to the connector 46.

The coupler 60 and the other components of the icing dispenser 128 may be manufactured from a plastic, a metal, or other material(s) that does not combine with food products when in contact with such products (e.g., icing).

During use of the icing dispenser 128, a user determines an icing bead shape that is desired to be extruded, selects an icing dispensing tip that will provide the desired bead shape, such as, tip 34 (or another tip, e.g., tip 134a, or tip 134b shown in FIG. 7), then using the selected tip, the user assembles the dispenser 128. Once assembled, the user provides the icing in the bag 10, and applies pressure to the bag 10 thereby forcing the icing through bag nozzle 14 which is fixedly coupled to the housing 64 via the threaded component 88. The icing subsequently exits the bag nozzle 14 and enters the rotatable member 100, which can be rotated together with the tip connector 120 and the tip 34 so that the bead of icing exiting the icing dispenser 128 includes twists corresponding to the rotation of the connector tip 120 by the user.

Other extrudable substances (e.g., flowable and formable substances such as chocolate, soft cheese, or pastry dough) may be extruded from a dispenser having an embodiment of the coupler 60 operably provided along the flow path of the substance being extruded so that the extrusion can be twisted as it exits the dispenser. In particular, such a dispenser may include a fixed nozzle (similar to bag nozzle 14), a tip connector (similar to tip connector 120), and one of a plurality of extrusion tips (similar to tip 34) that can be secured to a rotatable member (similar to the rotatable member 100), wherein each of the dispenser components is dimensioned to appropriately extrude the intended substance in a desired manner. In particular, embodiments of the dispenser may provide for the interchanging of extrusion tips providing different extrusion shapes. In the context of icing (and/or other similar flowable and formable food stuffs), FIG. 7 shows two alternative tips 134a and 134b that can be used with the dispenser 128 for providing different shapes (twisted or not) in the extruded substance.

Note that the twisting functionality of such a dispenser also may be used for other purposes than provide decorative shapes of foodstuffs. In particular, such twisting action as provided by a dispenser having an embodiment of the coupler 60 may be used to further mix, fold or twist substantially any extruded substance. For example, if the rotation of the tip 34 is motorized, the resulting twisted extrusion can be useful in, e.g., the making of candy such as the twisting of candy canes or taffy, the twisting of dough, the further mixing of ground meat products, etc. In such additional applications, instead of low friction sliding surfaces for the sides of each of the gaps G and H, sealed bearings may be provided therebetween, as one of ordinary skill in the art will understand.

In one embodiment, an additional rotation wheel 136 (FIG. 7) may be added as a separate component attached or adhered to the rotatable member 100 or to the tip connector 120, wherein the rotation wheel provides a user with an expanded extent which the user can contact for rotating the tip 34. In particular, the rim or outer surface 140 of the rotation wheel 136 extends outwardly further than the housing 64 so that, e.g., for dispensing icing, a user can grasp the icing dispenser 128 near (or at) the housing 64, and more easily rotate the tip 34 (while icing is being dispensed) by rotating the rim 140 with a finger or thumb. As also shown in FIG. 7, there may be various alternative shapes for the rotation wheel 136 (e.g., 136a, 136b, and 136c), wherein their respective rims 140a, 140b, and 140c may provide enhanced rotation control for a user.

As indicated above, an embodiment of a dispenser according to the present disclosure may include a motor (not shown) for supplying the rotational force for twisting the extrudable substance (e.g., icing). Such a motor may rotationally drive a belt that loops around the rotatable member 100, the tip connector 120, or a wheel 136. In another embodiment, such a motor may have a drive gear (not shown) that meshes with a rotation wheel such as 136c for twisting the extrudable substance. Note that the motor can have a motor controller (not shown) for controlling the speed of the motor and consequently varying the tightness of the twist in the extruded substance. Moreover, the motor (and controller) can be of sufficiently small size so that it can be provided on a wrist mount, or hand held mount, or attached directly to the coupler 60 (or other embodiments thereof) so that finger or thumb movements of a user adjusts the speed of the motor, and accordingly a tightness of the twist. In particular, a finger lever may be provided for varying the speed of the motor.

The rotation wheel 136 (and/or 136a, 136b, and 136c) may be manufactured from a plastic, a metal, or other material(s). For food extrusion applications, the wheel 136 is preferably composed of a non-food contaminating material. Additionally, in order for the wheel 136 (and/or 136a, 136b, and 136c) to rotate easily relative to the housing, the wheel surface facing the housing 64 may be a low friction non-stick plastic, or there may be sealed bearings between the wheel and the housing. However, in at least one embodiment, the surface of the rotation wheel 136 facing the rotatable member 100 or the tip connector 120 may include friction enhancing features such as ridges, indentations, and/or a non-smooth surface so that rotation of the wheel 136 causes the rotatable member 100, the tip connector 120 and the tip 34 rotate synchronously with a rotation of the wheel. Note, that in some embodiments, the surface of the wheel 136 facing the tip connector 120 also may be smooth. In one embodiment, the wheel 136 may include a notch, detent, or projection that mates with, e.g., a portion of the rotatable member 100 for securely synchronizing the movement of the rotatable member (and the tip 34, 34a or 34b) with the rotation of the wheel 136. In one embodiment, the wheel 136 may be integral with either the rotatable member 100, or the tip connector 120. In another embodiment, the wheel 136 may be molded to either the rotatable member 100, or the tip connector 120.

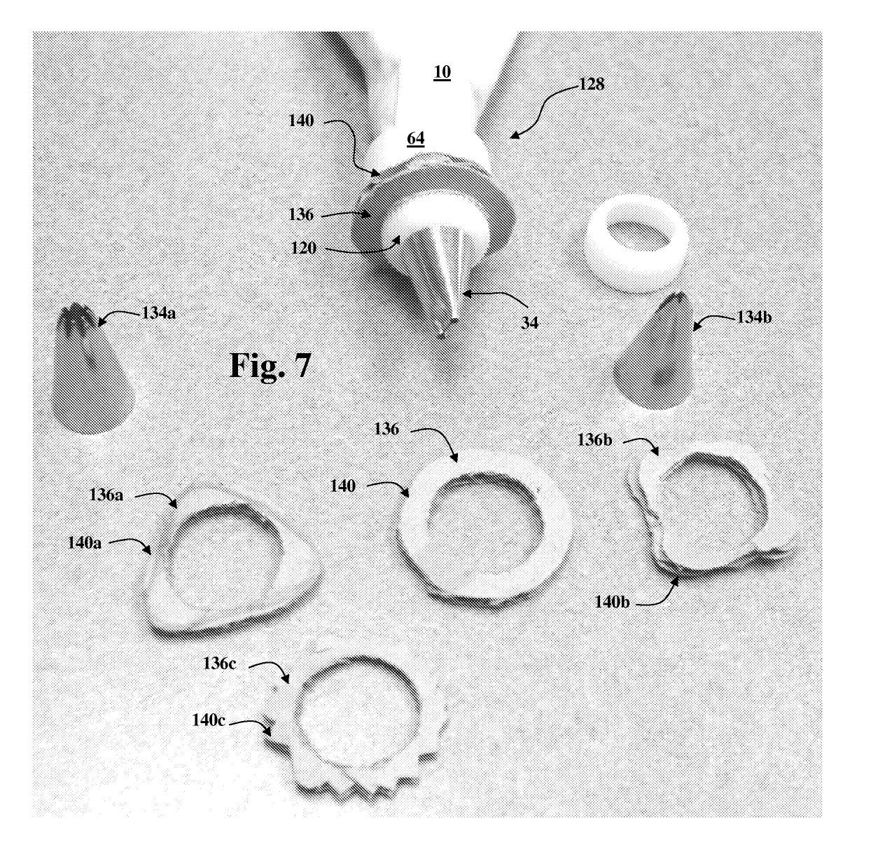

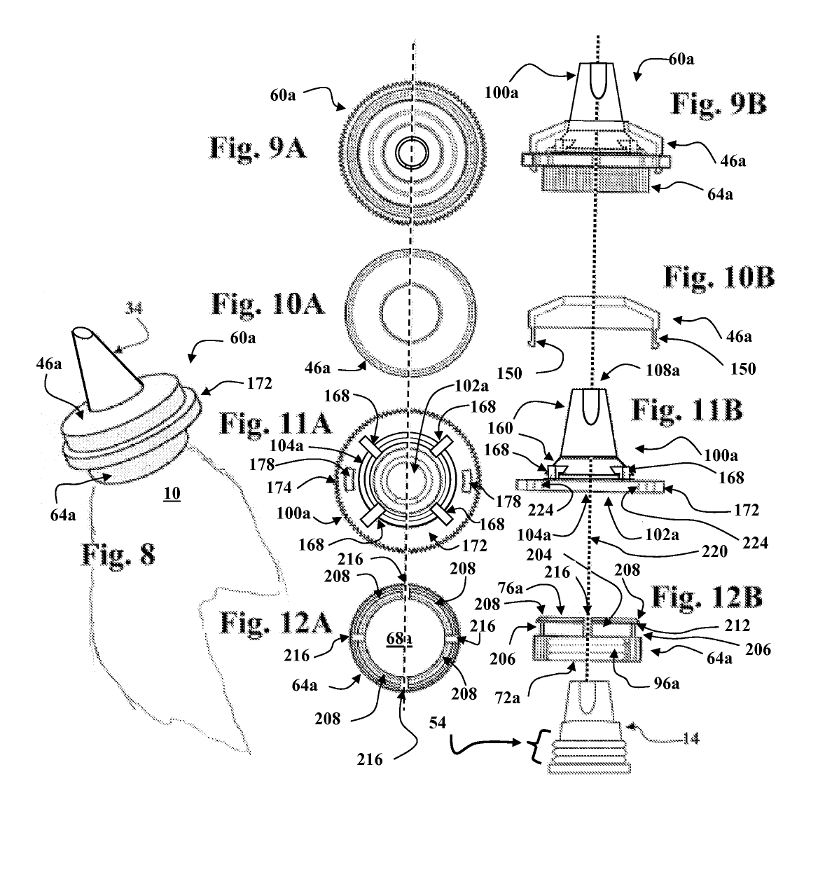

A second embodiment of the rotatable dispensing coupler (identified by the label 60a) is shown FIGS. 8-12B, wherein FIGS. 9A and 9B show a fully assembled coupler without the tip 34 attached, and FIG. 8 shows the fully assembled coupler 60a with the tip 34 attached thereto. Note that the components and features corresponding to those of coupler 60 described hereinabove are labeled with the identical number followed by an “a”. The coupler 60a includes the following three components:
(1) a connector 46a (e.g., FIGS. 10A and 10B) having similar functionality to the connector 46 described above, e.g., for securing an icing dispensing tip 34 (FIG. 8) to the coupler 60a (FIG. 8). Additionally, the connector 46a includes at least two snap locks 150 for securing this connector to the rotatable member 100a as described below;
(2) a rotatable member 100a (e.g., FIGS. 11A and 11B) having similar functionality to the rotatable member 100 described above, e.g., having an interior 102a through which icing flows from its icing entry end 104a (FIG. 11B) to the icing exit end 108a which fits inside of an icing dispenser tip 34, and from which the icing enters the tip 34. Additionally, the rotatable member 100a also includes an icing funnel 160 connected by spacers 168 to a thumb/finger rotatable wheel 172 having a friction enhancing edge 174 to facilitate rotation by a user's thumb or finger. The wheel 172 includes lock cutouts 178 for mating with the snap locks 150, and thereby securing the connector 46a and rotatable member 100a together. Note that the spacers 168 are configured so that they fit within the interior of the connector 46a when the snap locks 150 mate with the lock cutouts 178. In one embodiment, for each spacer 168, the portion of the interior of the connector 46a immediately covering/contacting the spacer may be notched so that part of the spacer fits into the notch when the connector and the member 100a are secured together. In another embodiment, all spacers 168 may be merged into a single circular connection between the wheel 172 and the icing funnel 160, wherein the space between the wheel and the funnel is entirely enclosed;
(3) a housing member 64a (e.g., FIGS. 12A and 12B) having similar functionality to the housing member 64 described above, e.g., having a cylindrical interior 68a with an opening 72a for insertion of the nozzle 14, and an open end 76a at an opposite end from the opening 72a. Note that the housing 64a includes interior threads 96a for mating with the threads 54 of the bag nozzle 14. Additionally, the housing member 64a includes a plurality of protrusions 204 (four in the present embodiment, although fewer or more may be provided), each protrusion 204 includes an arcuate wall 206 with a slanted overhang 208 attached to the end of the wall adjacent to the open end 76a. Each of the protrusions 204 includes a surface 212 that faces in the direction of the opening 72a. The four walls 206 are in a cylindrical arrangement, wherein the outer diameter of this arrangement is smaller than the diameter of the icing entry end 104a of the rotatable member 100a, but wherein the outer diameter of the circular configuration of the four surfaces 212 is greater than the diameter of the icing entry end 104a.

The assembly and operation of the coupler 60a is as follows. Once the bag nozzle 14 is inserted into the icing bag 14 opening, the housing 64a may be threaded onto the bag nozzle via the mating threads 96a and 54. The rotatable member 100a snap fits onto the housing 64a via the four identical protrusions 204 of the housing 64a entering the icing entry end 104a. In particular, when each of the slanted overhangs 208 is placed in contact with the diameter of the icing entry end 104a, and the housing 64a and the rotatable member 100a are squeezed together, the gaps 216 between the protrusions 204 allow these protrusions to bend toward the center axis 220 as the icing entry end 104a slides over the slanted overhangs 208. Moreover, since the funnel 160 is spaced apart from wheel 172, and since the spacers 168 (or a single circular closed spacer) attach to the wheel 172 away from the interior walls 224 of the icing entry end 104 of the wheel 172, there is a circular channel in which the slanted overhang 208 can seat. Accordingly, once the surfaces 212 slide past the interior walls 224, the protrusions 204 snap back into their original shape, thereby securing the housing 64a and the rotatable member 100a together. Subsequently, the icing exit end 108a is inserted into an icing tip 34, and the snap locks 150 of the connector 46a are snapped into the lock cutouts 178, the coupler 60a is fully assembled as shown in FIGS. 8, 9A and 9B.

Operation of the coupler 60a is substantially the same as described hereinabove for the coupler 60.

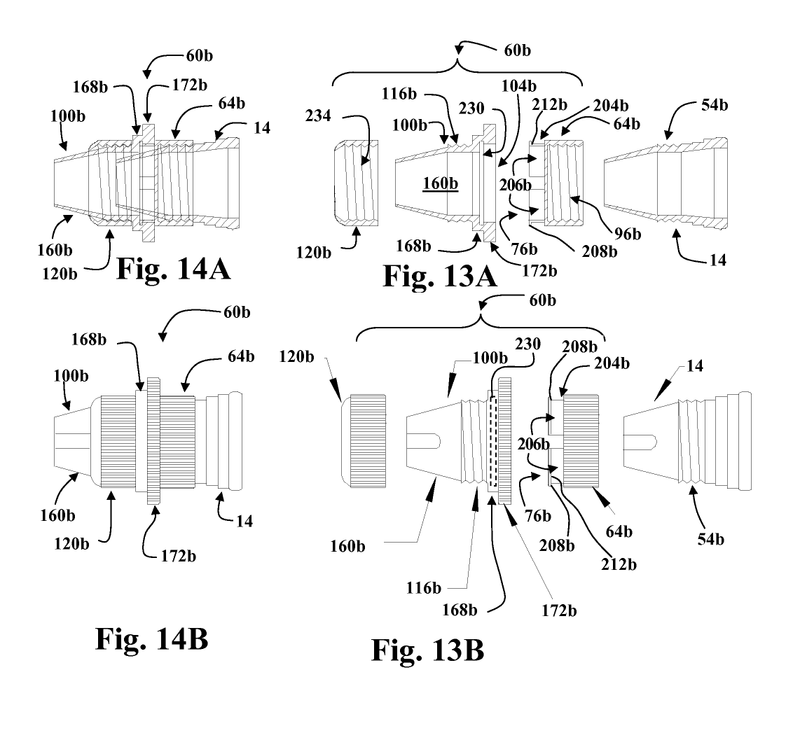

A third embodiment of the rotatable dispensing coupler 60b is shown in FIGS. 13A-14B. This third embodiment incorporates features from both the first and the second embodiments described hereinabove. Referring to FIGS. 13A and 13B, the coupler 60b is shown expanded in each of these figures thereby showing the rotatable dispensing coupler's three components, namely, a housing member 64b identical (or substantially so) to the housing 64a, a rotatable member 100b that corresponds to rotatable member 100a, and a tip connector 120b which may be identical (or substantially so) to the tip connector 120 of the rotatable dispensing coupler 60 of the first embodiment described hereinabove. In particular, FIGS. 13A and 13B show the rotatable dispensing coupler 60b together with a conventional bag nozzle 14, wherein FIG. 13A is a cross sectional view of FIG. 14A. In the description following, features/components identical (or substantially so) to features/components described hereinabove may be identified by the same numerical label with a “b” annotated thereto.

The rotatable member 100b shown in this third embodiment of the rotatable dispensing coupler includes a circular spacer 168b for surrounding and attaching the icing funnel 160b to the rotatable wheel 172b. Note that the spacer 168b may be without breaks or openings in its circular attachment to the icing funnel 160b, and also to its circular attachment to the rotatable wheel 172b. However, breaks or openings are within the scope of the present disclosure, whereby the spacer 168b may be a plurality of spacers more similar to the spacers 168 of FIGS. 11A and 11B. As shown in FIG. 13A, the interior of the spacer 168b includes a circular track 230 that surrounds the icing flow path through the rotatable member 100b. The circular track 230 is configured to receive the overhangs 208b of the housing member 64b.

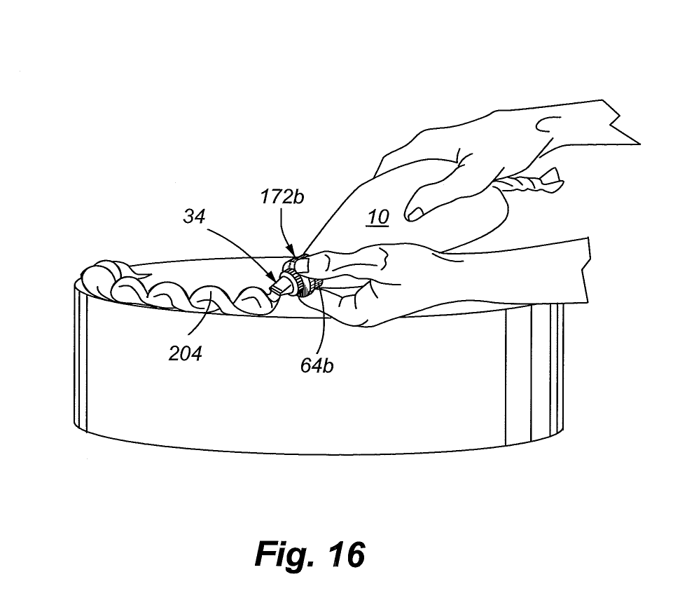

The housing member 64b includes a plurality of protrusions 204b (four in the present embodiment, although fewer or more may be provided), each protrusion 204b includes an arcuate wall 206b having one of the overhangs 208b attached to the end of the wall adjacent to the open end 76b of the housing 64b. Each of the protrusions 204b includes a surface 212b that faces away from the open end 76b. The four walls 206b are in a cylindrical arrangement about the flow path of the icing (or other extrudable substance), wherein the outer diameter of this arrangement is smaller than the diameter of the icing entry end 104b (FIG. 13A) of the rotatable member 10b, but wherein the outer diameter of the circular configuration of the four surfaces 212b is greater than the diameter of the icing entry end 104b. Accordingly, when the overhangs 208b are forced into the circular track 230, these overhangs couple the rotatable member 100b and the housing member 64b together. However, this coupling is sufficiently loose so that the overhangs 208b are rotatable about the track 230 when a user supplies a rotational motion to the wheel 172b (of a fully assembled coupler 60b) with his/her finger(s) or thumb. Thus, the member 100b is rotatable relative to the housing member 64b when the user applies such a rotational motion as, e.g., shown in FIG. 16.

As one of ordinary skill in the art will appreciate and understand, the coupling of the housing 64b and the rotatable member 100b can be inverted, wherein the track 230 is included in the housing 64b, and the protrusions 204b may be provided as part of the rotatable member 10b.

The rotatable member 100b further includes threads 116b for mating with the threads 234 (FIG. 13A) interior to the tip connector 120b, and thereby securing an icing tip 34 (not shown in FIGS. 13A-14B) to the rotatable member 100b in a manner identical (or substantially so) to securing such an icing tip 34 to the rotatable member 100 as described hereinabove with reference to FIGS. 2 and 3.

Accordingly, once the rotatable member 100b and the housing member 64b are fitted together (e.g., via snap fitting together, threading together, etc.), the threads 96b (FIG. 13A) interior to the housing 64b are used to secure the housing 64b to the bag nozzle 14 (via the threads 54b), and the tip connector 120b is used to secure an icing tip 34 to the rotatable member 100b. Subsequently, assuming a user previously filled the bag 10 attached to the bag nozzle 14, the user can then apply hand or arm pressure directly to the bag for extruding icing (or another extrudable substance) from the bag through the dispensing coupler 60b, and concurrently rotate the wheel 172b so that icing exits the coupler 60b having a twisted configuration. FIG. 16 illustrates a twisted icing extrusion 204 exiting an icing tip 34 as a user applies pressure to the bag 10 while rotating the wheel 172b. Accordingly, by attaching various tips 34 to the coupler 60b (or 60 or 60a), wherein the icing exit opening of different tips is differently shaped (e.g., different cross sectional shapes such as oval, star shaped, ribbon-like, etc.), the user can create a plurality of twisted icing designs.

Moreover, as mentioned hereinabove, it is within the scope of the present disclosure that rotation of the rotatable member (100, 110a, or 100b) can be rotated via a small electric motor that is, e.g., battery powered, and activated at various rotational speeds by finger movements of the user. For example, a user may supply pressure to be icing bag 10 with one hand (or arm), and control both the placement of the extruded icing and the (any) rotational speed of such a motor with the other hand. In one embodiment, the drive train for transferring rotational movement from the motor to the rotatable member may be an elastomeric belt that fits around the rotatable member in an annular groove on the exterior surface of the rotatable member, and wherein the groove replaces the wheel 172 (or variations thereof). Note, the gear ratio from the motor to the groove may be in the range of at least five to one, and more preferably about ten to one.

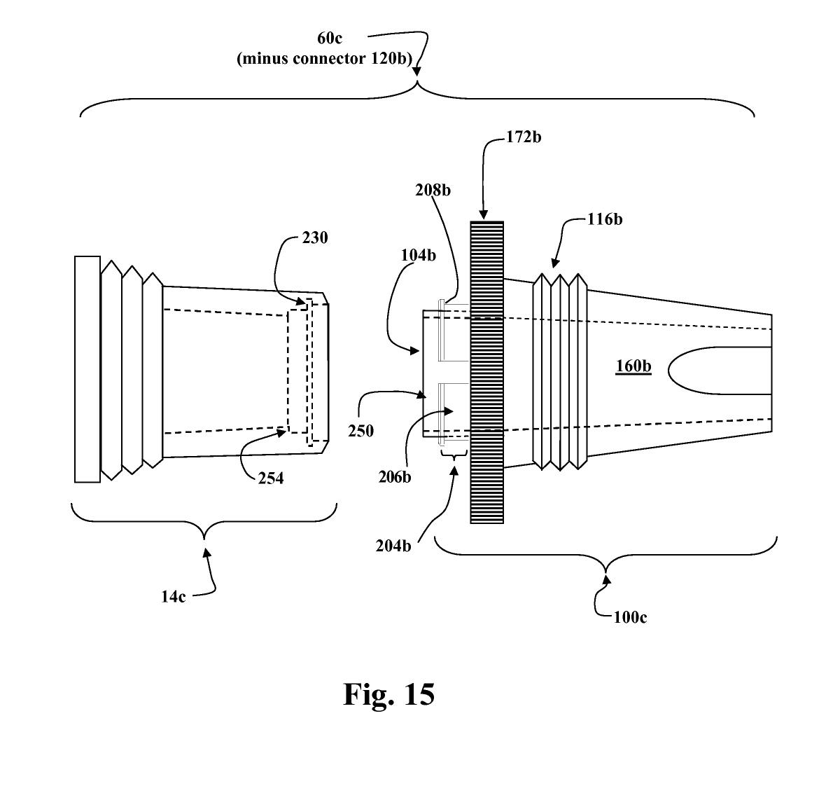

In another embodiment, the bag nozzle 14 and the housing member (64, 64a, or 64b) may be combined into a single component. For example, the coupling of the housing member and the rotatable member may be inverted as described hereinabove, wherein the track 230 can be provided within a modified bag nozzle. FIG. 15 shows an illustrative embodiment of the fourth embodiment of the coupler 60c (without its tip connector, e.g., connector 120b of FIGS. 13a and 13B). In FIG. 15, the modified bag nozzle is labeled 14c, and the corresponding rotatable member is labeled 100c. Features of each of these components are identified with the same labels for identifying corresponding components as was used in FIGS. 13A-14B whenever appropriate. Accordingly, the components 14c and 100c fit together by a user fitting the overhang 208b (FIG. 15) into the track 230 (FIG. 15) so that the component 100c can rotate relative to the bag nozzle 14c. Note that when the two components are coupled, a flow path extension 250 fits within an annular ring 254 surrounding the icing flow path in the bag nozzle 14c so that no appreciable amount of icing comes in contact with the track 230 (FIG. 15).

The foregoing discussion has been presented for purposes of illustration and description. Further, the description is not intended to limit the invention(s) herein to the form disclosed herein. Consequently, variation and modification commiserate with the above teachings, within the skill and knowledge of the relevant art, are within the scope of the present disclosure. The embodiments described hereinabove are further intended to explain the best mode presently known of practicing the invention claimed hereinbelow, and to enable others skilled in the art to utilize the claimed invention as such, or in other embodiments, and with the various modifications required by their particular application or uses of the invention.

What is claimed is:

1. An icing dispenser coupler, comprising:
a first member having an interior passageway, and first and second opposing open ends of the passageway, the first end for receiving icing from an icing reservoir;
a second member having an icing flow path there through between an icing entry end, and an icing exit end, wherein when the first member and the second member are engaged for providing an icing flow path between the first end, and the icing exit, a portion of at least one of the second member and the first member restricts a disengagement of the first member and the second member,
wherein when the first member and the second member are engaged together, the second member is rotatable relative to the first member;
a connector for connecting to the second member, and attaching any tip of a plurality of icing dispensing tips to the second member, wherein when icing flows through the icing flow path, the icing enters the tip, and the tip also rotates when the second member rotates;
wherein at least a portion of the tip is secured between the connector and the second member for inhibiting the detachment of the tip from the second member;
wherein the connector is detachable from the second member for detaching the tip from the second member, and attaching a second of the plurality of icing dispenser tips to the second member when the connector is reconnected to the second member with at least a portion of the second tip secured between the connector and the second member.

2. The coupler of claim 1, wherein the portion includes one of a lip and a track for connecting the first member and the second member together so that the second member is rotatable relative to the first member.

3. The coupler of claim 1, wherein the first member snap fits with the second member.

4. The coupler of claim 1, wherein within the first member are threads for threading onto threads of an icing bag nozzle, wherein the threads of the icing bag nozzle also mate with an attachment for attaching the tip to the icing bag nozzle without the coupler so that when icing flows out of the icing bag nozzle, the icing flows into the tip.

5. The coupler of claim 1, wherein the attachment is interchangeable with the connector.

6. The coupler of claim 1, wherein within the first member are threads for threading onto threads of an icing bag nozzle, the threads within the first member being provided by a component fitted into the first end of the first member.

7. The coupler of claim 6, wherein the threads of the icing bag nozzle also mate with an attachment for attaching the tip to the icing bag nozzle without the coupler so that when icing flows out of the icing bag nozzle, the icing flows into the tip, and wherein the attachment is interchangeable with the connector.

8. The couple of claim 1, wherein the icing reservoir includes an flexible bag for containing the icing, ant the first member attaches to the bag through an opening in the bag for dispensing icing.

9. The coupler of claim 1, wherein the second member includes one of a lip and a track encircling the icing flow path through the second member;
wherein the one of a lip and a track is used to couple the first member and the second member together so that the second member is rotatable relative to the nozzle first member.

10. The coupler of claim 1, further including a wheel for rotating the second member, wherein the wheel surrounds the icing flow path, and the wheel has a larger outer diameter than an adjacent extent of the coupler traverse to the flow path.

11. The coupler of claim 1, wherein the coupler includes one or more of the components or features shown in one or more of the FIGS. 2 through 8, 9A, 9B, 10A, 10b, 11A, 11B, 12A, 12B, 13A, 13B, 14A, 14B, 15 and 16 disclosed herewith.

12. The coupler of claim 1, wherein the coupler includes one or more features and components disclosed in one or more of the Summary, the Brief Description of the Drawings, and the Detailed Description provided herewith.

13. A method for providing a coupling for twisting a substance as it is extruded, comprising:
providing a first member having an interior passageway, and first and second opposing open ends of the interior passageway, the first end for receiving the substance from a reservoir of the substance;
providing a second member having flow path for the substance there through between an entry end, and an exit end of the second member, wherein the first member and the second member engage for providing a second flow path of the substance between the first end, and the exit end;
wherein when the first member and the second member are engaged together, the second member is rotatable relative to the first member by a finger or thumb providing a force for rotating the second member relative to the first member;
providing a connector for connecting to the second member, and attaching any tip of a plurality of dispensing tips to the second member, wherein when the substance flows through the second flow path, the substance enters the tip, and the tip rotates when the second member rotates about the second flow path;
wherein at least a portion of the tip is secured between the connector and the second member for inhibiting the detachment of the tip from the second member;
wherein the connector is detachable from the second member for detaching the tip from the second member, and attaching a second of the plurality of dispensing tips to the second member when the connector is reconnected to the second member with at least a portion of the second tip secured between the connector and the second member.

14. The method of claim 13, further including coupling together the first member and the second member wherein there is a track surrounding the second flow path, and the coupling occurs via a snap fit of one of the second member and the first member into the track.

15. The method of claim 13, wherein the first member, the second member, and the connector are provided with one of: an icing dispensing bag, an icing bag nozzle, and at least one of the plurality of icing dispensing tips.

16. The method of claim 13 further including a step of providing a motor for rotating the second member relative to the first member.

17. An icing dispenser coupler in the context of cake decorating, for coupling to an icing bag nozzle, wherein the bag nozzle has an icing passageway extending between corresponding ends thereof, comprising:
a first member having an interior with an opening for insertion of the bag nozzle, and a second opening at an opposite end of the nozzle first member;
a rotatable second member having one of a lip or a track encircling an icing flow path through the rotatable second member;
wherein the one of a lip or a track is used to couple the first member and the rotatable second member together so that the rotatable second member is rotatable relative to the first member;
a wheel attached to the rotatable second member, the wheel for rotating the rotatable second member relative to the first member when a user supplies a rotational force to the wheel with a finger or thumb so that rotation of the wheel causes the rotatable second member and an icing tip dispenser to rotate with a rotation of the wheel;
wherein the wheel includes a friction enhancing feature including one or more of: ridges, indentations, and/or a non-smooth surface;
wherein when the rotatable second member includes a track, the first member includes a plurality of protrusions, each protrusion including an arcuate wall with an overhang attached to an end of the wall;
wherein the walls are in a cylindrical arrangement, wherein an outer diameter of the arrangement is smaller than the diameter of an icing entry end of the rotatable second member, but the outer diameter of the overhangs is greater than the diameter of the icing entry end.

18. An icing dispenser coupler, comprising:
a first member having an interior passageway, and first and second opposing open ends of the passageway;
a rotatable second member having an icing flow path there through between an icing entry end, and an icing exit end, wherein the rotatable second member includes an expanded portion that is spaced apart, along the icing flow path, from the icing exit end;
wherein when the expanded portion of the rotatable second member is positioned within the interior passageway such that at least a portion of the rotatable second member between the expanded portion and the icing exit extends through the second open end of the first member, the expanded portion is prevented from exiting the passageway by at least a portion of the interior passageway, and the rotatable second member is rotatable both about a direction of the icing flow path, and relative to the first member;
a connection portion providing at least part of the interior passageway, wherein the connection portion includes a feature for mating with an icing output end of an icing bag nozzle that receives icing from an icing reservoir, the feature for mating secures the first member to the icing nozzle;
wherein the connection portion is spaced apart from the second open;
wherein the rotatable second member further includes a configuration on an exterior surface thereof for mating with a connector, wherein when the icing exit end is inserted into an icing entry opening (O₁) of a first of a plurality of icing tips such that the icing entry opening O₁ is positioned between the configuration and the connector, and the connector mates with the configuration, then the first tip is secured to the rotatable second member for rotating synchronously with the rotatable second member;
wherein the configuration and the connector are detachable so that when the icing exit end is inserted into an icing entry opening (O₂) of a second of the plurality of icing tips such that the icing entry opening O₂ is positioned between the configuration and the connector, and the connector is again mated with the configuration, then the second tip is secured to the rotatable second member for rotating synchronously with the rotatable second member.

19. A method for producing a twisted extrusion of icing for cake decorating, comprising:
applying hand or arm pressure to an icing bag so that icing therein extrudes through a bag nozzle attached to the bag, wherein the icing flows through a pathway within at least one additional component that is rotatable relative to the bag nozzle, and wherein the additional component connects to an icing tip so that the tip rotates with the additional component; and
rotating the additional component, via a rotational force of a finger or thumb, so that icing exiting the tip is twisted.

20. The method of claim 19, further including:
detaching the tip from the additional component;
attaching a different tip to the additional component;
applying hand or arm pressure to an icing bag so that icing therein extrudes through the bag nozzle attached to the bag, wherein the icing flows through the pathway within the additional component;
rotating the additional component, via a rotational force of a finger or thumb, so that icing exiting the different tip is twisted.

21. The method of claim 19, wherein the rotating step includes rotating a wheel surrounding the pathway.

22. The method of claim 16, further including:
coupling the additional component with at least one of component from: the bag nozzle, and an intermediate housing component;
wherein the coupling uses one of a lip and a track on one of the additional component and the at least one component to inhibit a decoupling, and to allow for a rotation of the additional component relative to the at least one component.
